(19) United States
(12) Patent Application Publication
(10) Pub. No.: US 2025/0113860 A1
(43) Pub. Date: Apr. 10, 2025

(54) PORTABLE ASHTRAY

(71) Applicant: LOOK CO., LTD., Tokyo (JP)

(72) Inventor: Noriyoshi MIURA, Tokyo (JP)

(21) Appl. No.: 18/431,244

(22) Filed: Feb. 2, 2024

(30) Foreign Application Priority Data
Oct. 5, 2023 (JP) 2023-173799

(51) Int. Cl. A24F 19/14; A24F 13/18; A24F 19/00; B32B 15/082; B32B 15/20; B32B 27/08; B32B 27/30

(52) U.S. Cl. CPC A24F 19/14; A24F 13/18; A24F 19/0014; A24F 19/0064; B32B 15/082; B32B 15/20; B32B 27/08; B32B 27/306; B32B 2439/46

(57) ABSTRACT

A portable ashtray is composed of an outer soft synthetic resin sheet and an inner soft metal film wholly superimposed on each other. The portable ashtray is equipped with a housing portion to contain cigarette butts, a lid portion that can open and close the opening of the housing portion, a fire extinguishing portion that is provided inside the housing portion, which has a cylindrical shape and which is opened to contain the tip of a cigarette inserted into the housing portion and extinguished. The extinguishing section consists of a first extinguishing section that accommodates and extinguishes the tip side of regular size cigarettes, a second extinguishing section with a smaller diameter than the first extinguishing section that accommodates and extinguishes the tip side of slim size cigarettes provided in connection with this first extinguishing section, and a cleaning tool for the extinguishing section.

### CROSS-REFERENCE TO RELATED APPLICATIONS

This patent application claims the benefit and priority of Japan Application No. 2023-173799, filed on Oct. 5, 2023, the disclosure of which is incorporated by reference herein in its entirety as part of the present disclosure.

### TECHNICAL FIELD OF INVENTION

This invention relates to a portable ashtray that can be used as an ashtray when smoking, can extinguish a lit cigarette after smoking, and can then be carried with the ashes and cigarette butts contained inside.

### BACKGROUND

The number of places where smoking is prohibited is increasing with the growing trend toward non-smoking, and the number of fixed ashtrays in parks and commercial facilities is decreasing. As a result, smokers increasingly need to carry their own portable ashtrays, each in its own pocket or bag.

The Japanese Patent Publication No. 2005-87103 discloses a portable ashtray in which cigarette butts extinguished by the fire extinguishing section provided inside the housing section are stored in the housing section. The extinguishing section is formed into a foldable bag shape using a resin sheet with the same material (aluminum sheet) as the housing section attached to both sides.

Japanese registered utility model No. 3093608 discloses a portable ashtray with a one-touch opening fitting at the opening of the compartment, in which cigarette butts extinguished by the extinguishing part provided inside the compartment are stored in the compartment. The extinguishing portion is a fire extinguishing cylindrical device having an inner diameter approximately the same as that of a regular size cigarette.

In recent years, an increasing number of people smoke what are known as slim-size cigarettes with diameters of 6 mm and 5 mm, as opposed to what are known as regular-size cigarettes with diameters of 7 mm and 8 mm. Since the diameter of slim size cigarettes is smaller than that of regular size cigarettes, it takes time to extinguish them with the above-mentioned fire extinguishers designed for known regular size cigarettes, and there is a possibility of failure in extinguishing them.

### SUMMARY

The purpose of this invention is to provide a portable ashtray with an extinguishing unit that can quickly extinguish both regular and slim size cigarettes, and a cleaning tool that can clean ashes stuck in this extinguishing unit.

In order to achieve the aforementioned purpose, the portable ashtray of the invention as described in claim 1 is composed of a soft synthetic resin sheet constituting the outside and a soft metal film constituting the inside where the whole is superimposed on each other, and is equipped with a housing portion to contain cigarette butts, a lid portion that can open and close the opening of this housing portion, a fire extinguishing portion that is provided inside said housing portion, which has a cylindrical shape, and which is opened to contain the tip of a cigarette inserted into said housing portion and extinguished. The extinguishing section consists of a first extinguishing section that accommodates and extinguishes the tip side of regular size cigarettes and a second extinguishing section with a smaller diameter than the first extinguishing section that accommodates and extinguishes the tip side of slim size cigarettes provided in connection with this first extinguishing section, and is also equipped with a cleaning tool for the extinguishing section.

The portable ashtray of the invention according to claim 2 is characterized in that the fire extinguishing section consists of a metal pipe member having a first and a second fire extinguishing section whose inner diameter is varied in two steps in the axial direction, and is attached inside the housing section via a belt member.

The portable ashtray of the invention described in claim 3, characterized in that it has a first butt portion between the first and second extinguishing sections that butts up against the tip of a regular size cigarette and a second butt portion on the second extinguishing section that butts up against the tip of a slim size cigarette.

The portable ashtray of the invention as described in claim 4 is characterized in that the first butt portion is formed of a smooth curved surface.

The portable ashtray of the invention as described in claim 5 is characterized in that the second butt portion is provided with an ejection hole that allows the ashes of the inserted slim-size cigarettes to fall into the housing section.

The portable ashtray of the invention as described in claim 6 is characterized in that the cleaning tool comprises a brush member having a brush section and a handle, and a housing pipe that accommodates the brush member, which is removably installed into a housing hole in the housing section via the housing pipe.

The portable ashtray of the invention as described in claim 7 is characterized in that the metal pipe member is affixed to the interior of the housing.

The portable ashtray of the invention as described in claim 8 is characterized in that the second butt portion is provided with an ejection hole that allows the ashes of the inserted slim-size cigarettes to fall into the housing section.

The portable ashtray of the present invention, when configured as in claim 1, allows slim-size cigarettes to be inserted into the extinguishing section and extinguished as quickly as regular-size cigarettes, and also allows cleaning of the pipe-shaped extinguishing section with a cleaning tool to extend its product life.

The portable ashtray of the present invention, when configured as in claim 2, has a solid and simple configuration of the fire extinguishing part, can be provided at a low cost, and the fire extinguishing part is securely attached to the housing part by a belt member.

The portable ashtray of the present invention is configured as in claim 3, whereby regular size cigarettes are extinguished in that position against the first butt of the first extinguishing section and slim size cigarettes are extinguished in that position against the second butt of the second extinguishing section.

The portable ashtray of the present invention, when configured as in claim 4, the tip of a slim-size cigarette is smoothly guided to the second extinguishing section by the curved surface on the first butt section.

The portable ashtray of the present invention is configured as in claim 5, whereby the discharge holes allow ashes from extinguishing a fire to be smoothly discharged into the housing area without accumulating in the extinguishing section.

The portable ashtray of the present invention is configured as in claim 6, where the brush section is retained by the housing pipe without deformation even after use over time.

The portable ashtray of the present invention, when configured as in claim 7, is easy to install the metal pipe member into the housing section and can be manufactured inexpensively.

The portable ashtray of the present invention, when configured as in claim 8, reinforces the opening with a folded portion and prevents the opening from being deformed by heat when the ashes of a lit cigarette are placed against the opening and dropped into the housing during smoking.

### BRIEF DESCRIPTION OF DRAWINGS

FIG. 1 shows a diagram of the portable ashtray of the invention.

FIG. 2 is a plane view of the portable ashtray shown in FIG. 1 with the lid open.

FIG. 3 shows a plane view of the portable ashtray shown in FIG. 1 with the lid closed.

FIG. 4 shows the A-A cross section of FIG. 3.

FIG. 5 shows the B-B cross section of FIG. 3.

FIG. 6 shows the C-C cross section of FIG. 3.

FIG. 7 is an enlarged longitudinal section of the fire extinguishing portion of the portable ashtray.

FIGS. 8A and 8B show the fire extinguishing section of the portable ashtray, with FIG. 8A showing the metal pipe member and FIG. 8B showing the belt member.

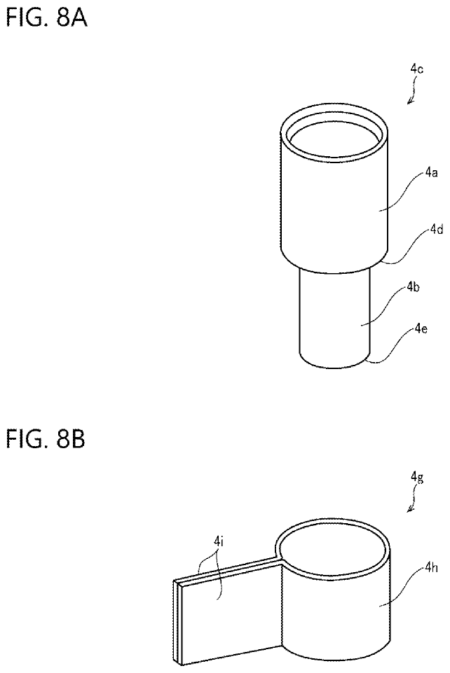

FIGS. 9A and 9B illustrate the portable ashtray cleaning tool, with FIG. 9A showing the front view of the brush member and FIG. 9B showing the housing pipe.

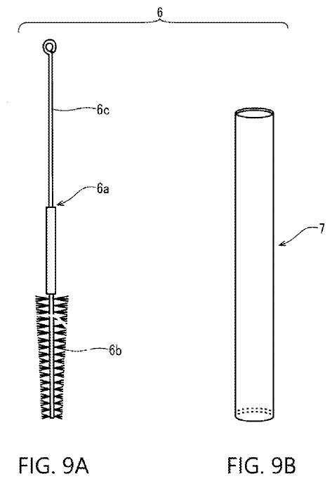

FIGS. 10A and 10B illustrate the use of the portable ashtray, with FIG. 10A showing its use for extinguishing cigarettes and FIG. 10B showing its use for cleaning the metal pipe members of the extinguishing section, respectively.

### DETAILED DESCRIPTION

The following is a detailed description of the portable ashtray for the present invention, with reference to the attached drawings.

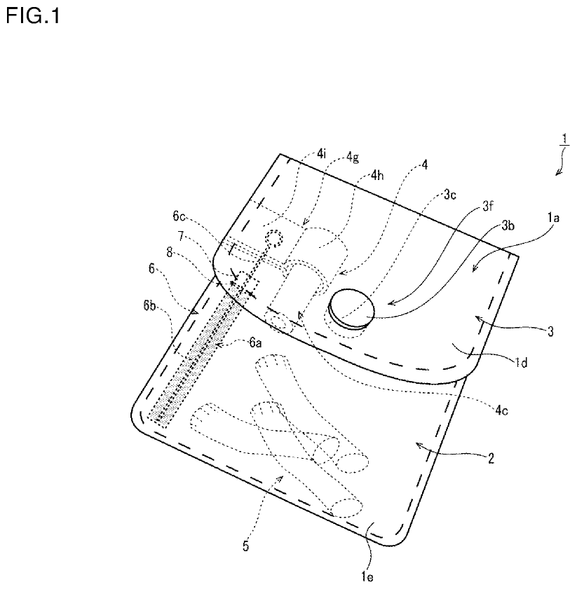

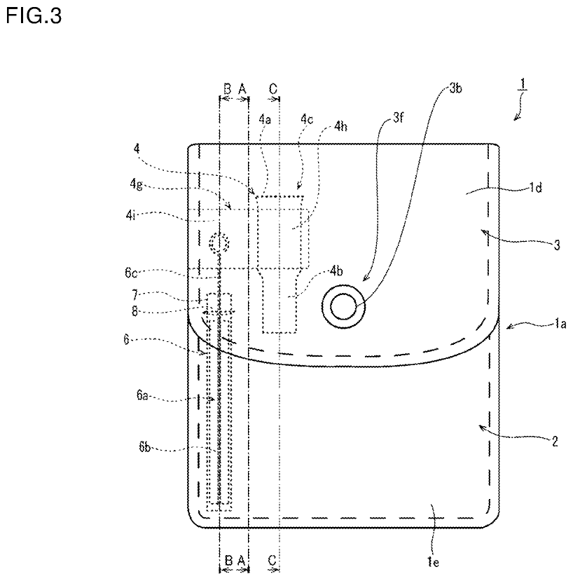

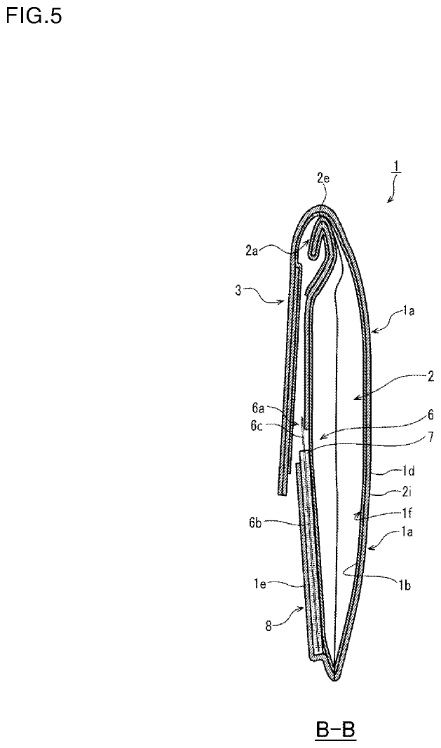

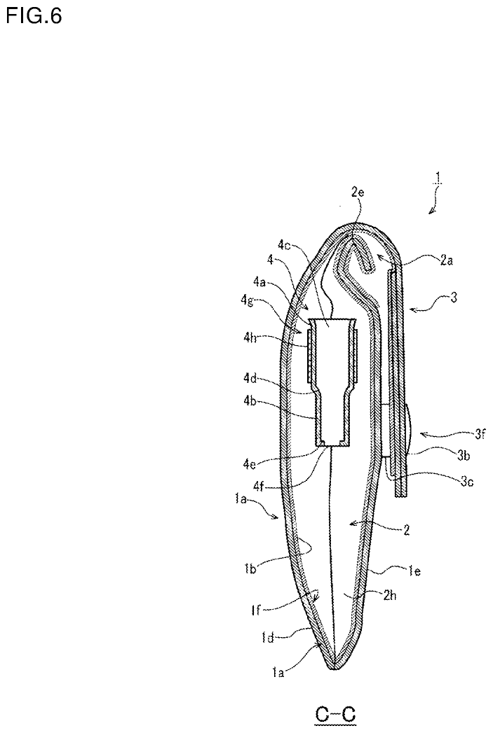

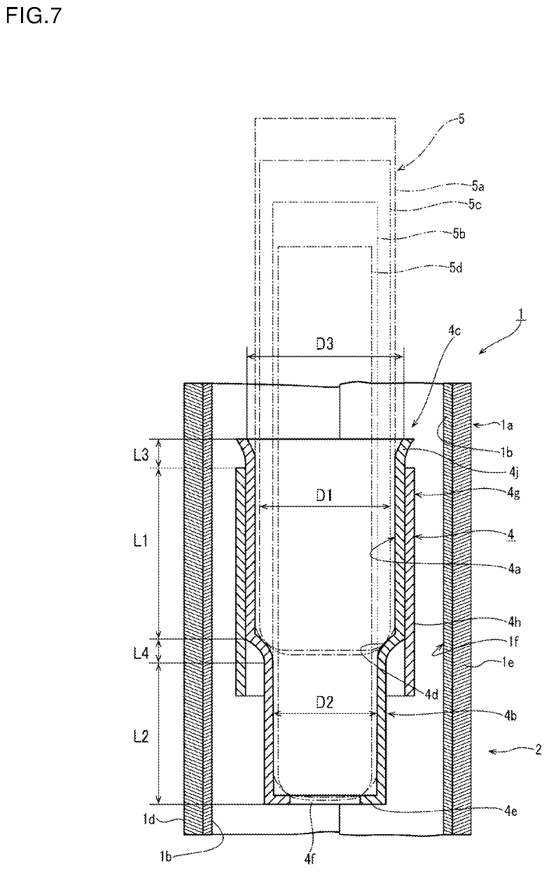

A portable ashtray 1, as an example of an embodiment of the present invention, comprises: an outer member 1a formed by overlapping a soft synthetic resin sheet 1d constituting the outside and another similarly soft synthetic resin sheet 1e of the same shape as the former, sewn together around their peripheries as shown particularly in FIGS. 1 to 6; a receiving portion 2 having an opening 2a formed between the soft synthetic resin sheet 1d constituting the outside, cut horizontally at the upper side of the synthetic resin sheet 1e constituting the inside of the outer member 1a, for accommodating cigarette butts 5; a metal film 1b entering from the opening 2a of the inner synthetic resin sheet 1e and covering the interior of the receiving portion 2, and a lid portion 3 covering the opening 2a of the receiving portion 2 and formed by bending the lid portion 3 to cover the opening 2a of the receiving portion 2 and fixing the lid portion 3 to the receiving portion 2 with a fixing means 3f; a fire extinguishing part 4 fixedly contained inside the receiving portion 2; and a cleaning tool 6 for cleaning the fire extinguishing part 4. The fire extinguishing part 4 comprises a first fire extinguishing section 4a for containing and extinguishing the lit tip of regular-sized cigarettes 5a, 5c, particularly as shown in FIG. 7, and a second fire extinguishing section 4b of smaller diameter than the first fire extinguishing section 4a, which contains and extinguishes the lit tip of slim-sized cigarettes 5b, 5d provided in communication with the first fire extinguishing section 4a.

The two synthetic resin sheets 1d and 1e, inner and outer, comprising the outer member 1a of the portable ashtray 1 are made of EVA (ethylene-vinyl acetate copolymer resin), for example, and the metal film 1b comprising the inner member 1f is made of soft aluminum foil, for example, but not limited to these.

The synthetic resin sheets 1d and 1e are sewn around each other, but may be glued together. The metal film 1b is glued together, but may also be sewn together.

The outer member 1a is constructed by sewing together the periphery of a synthetic resin sheet 1d and a synthetic resin sheet 1e, both of which are rectangular in shape and constitute the outer part, but is not limited to this method. For example, it may be constructed by thermocompression bonding or pasting.

The outer member 1a has an opening 2a cut horizontally near the upper side of the synthetic resin sheet 1e that constitutes its inner side, and following this opening 2a, a housing section 2 is formed between the synthetic resin sheet 1d that constitutes the outer side and the synthetic resin sheet 1e that constitutes the inner side, with the upper part from the opening 2a constituting the lid 3 constitutes the lid 3. The portion of the opening 2a of the outer member 1a is a folded portion 2e when the lid 3 is folded back against the accommodating portion 2.

The fastening means 3f consists of a female snap button 3b attached to the lid 3 side and a male snap button 3c attached at the upper side of the fire extinguishing section 4 on the housing 2 side. The attachment positions of the female snap button 3b and the male snap button 3c may be reversed. The securing means 3f may be a magic band, belt, or other known means, in short, any means that is heat resistant and does not easily open the closed lid 3 is sufficient.

Furthermore, the portable ashtray 1 of the present invention is provided with a fire extinguishing section 4 located near the center of the interior of the housing section 2. This fire extinguishing section 4, in the embodiment, consists of a metal pipe member 4c, which is an aluminum pipe formed by impact processing, and a belt member 4g that secures the metal pipe member 4c within the housing section 2. In addition to aluminum, the metal pipe member 4c may be made of duralumin, stainless steel, or other copper products, for example. The installation position of the fire extinguishing section 4 is not necessarily limited to that of the example.

The belt member 4g is a flexible, heat-resistant, or flame-retardant material, such as vinyl chloride, and includes a winding portion 4h and attachment portions 4i, 4i provided at both ends of this winding portion 4h. As shown in FIG. 7, the winding portion 4h is wound around the outer circumference of the metal pipe member 4c of the first fire extinguishing section 4a. The attachment portions 4i, 4i are sewn between the outer synthetic resin sheet 1d and the inner synthetic resin sheet 1e of the outer member 1a, thereby securing the metal pipe member 4c within the receiving portion 2. Additionally, adhesive tape can be attached to the outer side of the metal pipe member 4c with the adhesive side facing inward to adhere within the receiving portion 2.

As shown in FIG. 7, the metal pipe member 4c has a shaped large first extinguishing section 4a having an inner diameter D1 that fits regular size cigarettes 5a and 5c in the axial direction, and a second extinguishing section 4b having a smaller inner diameter D2 than the first extinguishing section 4a that is provided following this first extinguishing section 4a and fits slim size cigarettes 5b and 5d, which have a smaller outer diameter than regular size, inserted through the first extinguishing section 4a.

The metal pipe member 4c in this embodiment, as similarly shown in FIG. 7, has a total length of 22 mm. The inner diameter D1 of the first fire extinguishing section 4a, fitting the outer diameters of regular-sized cigarettes 5a (8 mm) and 5c (7 mm), is 8.4 mm. The inner diameter D2 of the second fire extinguishing section 4b, fitting the slim-sized cigarettes 5b (6 mm) and 5d (5 mm), is 6.3 mm. Furthermore, the entrance diameter D3 of the metal pipe member 4c is 9.4 mm. It includes a first curved section 4j with a length L3 of 2 mm, followed by an intermediate second curved section 4d with a length L4 of 2 mm. Additionally, the length L1 from the lower end of the first curved section 4j to the upper end of the second curved section 4d is 10 mm, while the length L2 from the lower end of the second curved section 4d to the second stopper 4e is 8 mm. However, these dimensions are not limited.

Furthermore, the portable ashtray 1 according to the present invention is equipped with a cleaning tool 6 for the metal pipe member 4c constituting the fire extinguishing part 4. This cleaning tool 6 comprises a brush member 6a consisting of a handle section 6c and a brush section 6b. It also includes a housing pipe 7 for storing the brush section 6b when not in use. The housing pipe 7 is designed to be inserted into a storage hole 8 inclined in one direction on the surface of the receiving portion 2, and the storage hole 8 is formed between the inner synthetic resin sheet 1e and the metal film 1b.

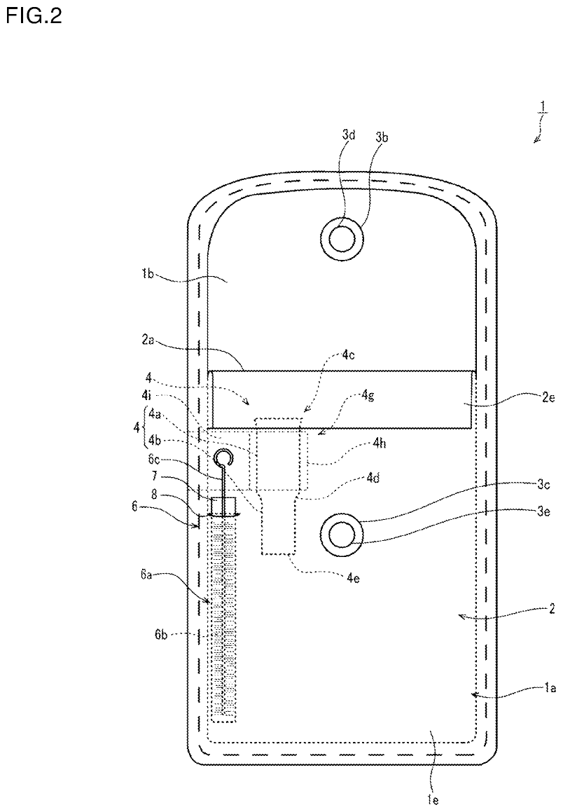

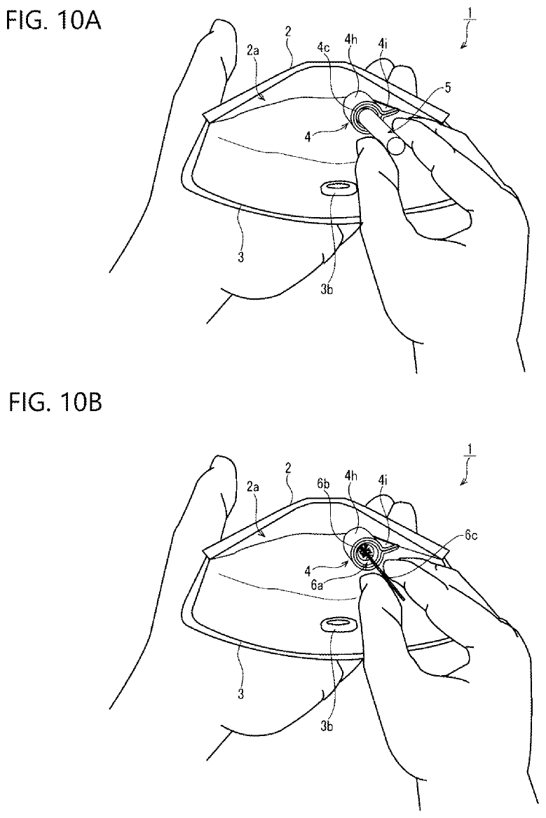

When smoking, as shown in FIG. 2, the smoker separates the female snap button 3b from the male snap button 3c, lifting the lid section 3 upward. By pressing the sides of the receiving portion 2, as illustrated in FIG. 10A, a pocket-like opening 2a is formed. This enables the ashes from the cigarette 5 to be dropped through the opening 2a into the receiving portion 2 for containment. Additionally, the opening 2a is equipped with a metal film fold 2e, which prevents the synthetic resin sheet 1e of the opening 2a from burning or deforming due to the flame of the cigarette 5.

After finishing smoking, the smoker, with regard to the extinguishment of the cigarette 5, firstly, for regular-sized cigarettes 5a and 5c, inserts the lit end into the first stopper 4d of the first fire extinguishing section 4a of the metal pipe member 4c constituting the fire extinguishing part until it reaches the stopper. By leaving it inserted for a certain time, approximately 3 to 4 seconds, the fire of the regular-sized cigarette 5a or 5c is effectively extinguished primarily by blocking oxygen supply. Similarly, for slim-sized cigarettes 5b and 5d, inserting the lit end into the second stopper 4e of the second fire extinguishing section 4b of the metal pipe member 4c until it reaches the stopper and leaving it inserted for a certain time, approximately 3 to 4 seconds, ensures the effective extinguishment of the fire of the slim-sized cigarette 5b or 5d primarily by blocking oxygen supply.

As described, the ash from the extinguished cigarettes 5 within the fire extinguishing part 4 falls and is contained within the receiving portion 2 through the discharge hole 4f. Subsequently, the cigarette butts after smoking are inserted through the opening 2a into the receiving portion 2 and, as shown in FIG. 1, are contained within it. Additionally, apart from the previously mentioned oxygen deprivation, the extinguishing of the cigarette 5 fire is also aided by the temperature difference between the metal pipe member 4c and the cigarette, contributing to its extinguishment.

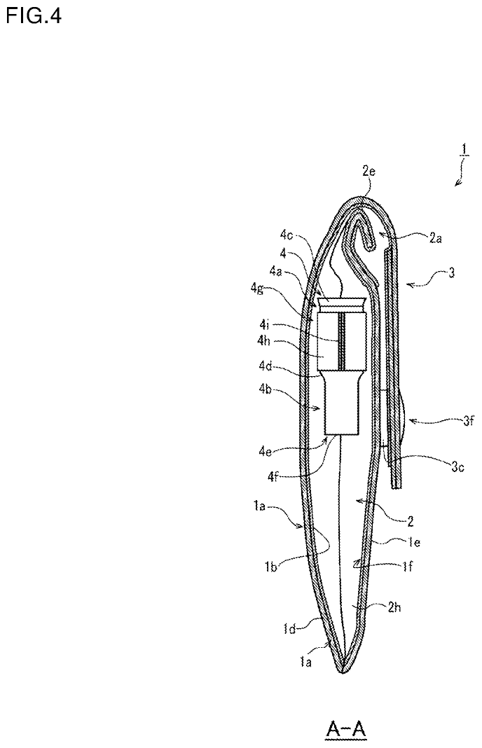

Next, the smoker folds the lid section 3 downward and, by pushing the male snap button 3c of the receiving portion 2 into the engagement recess 3d of the female snap button 3b of the lid section 3, can lock the lid section 3 into the receiving portion 2. At this point, as shown in FIG. 4, the lower part of the opening 2a is closed by the fold 2e, overlapping slightly, sealing the interior of the receiving portion 2. This prevents the spillage of accumulated ashes or cigarette butts from inside, ensuring that when the portable ashtray 1 is carried in a pocket or handbag, there is no concern about ashes or cigarette butts spilling out and soiling the pocket or bag.

Thus, the portable ashtray 1 according to the present invention is capable of extinguishing cigarettes with outer diameters of 8 mm and 7 mm, known as regular-sized cigarettes, in the first fire extinguishing section 4a. Additionally, in the second fire extinguishing section 4b, it can extinguish cigarettes with outer diameters of 6 mm and 5 mm, known as slim-sized cigarettes. This capability enables it to accommodate all four types of cigarettes currently sold in Japan.

When the metal pipe member 4c of the fire extinguishing part 4 gets clogged with ash, it can hinder the extinguishing of the cigarette 5 fire. The cleaning tool 6 is designed for this purpose: by removing the handle section 6c of the brush member 6a from the housing pipe 7 and inserting the brush section 6b into the metal pipe member 4c, it dislodges the accumulated ash within, allowing it to fall into the receiving portion 2 through the discharge hole 4f, or it helps to remove the ash by collecting it on the brush section 6b. Once the brush member 6a has been used, it is inserted back into the housing pipe 7 and kept inserted and held in the storage hole 8 provided in the receiving portion 2 along with the housing pipe 7.

As constructed above, the present invention allows for extinguishing all four types of cigarettes with different outer diameters currently sold in Japan. Moreover, by containing ashes and cigarette butts within the receiving portion, it ensures that there will be no spillage to the outside. This makes it a suitable and safe portable ashtray that can be carried in clothing pockets or bags with confidence, providing convenience and safety.

What is claimed is:

1. A portable ashtray comprising:
a soft synthetic resin sheet constituting an outside portion;
a soft metal film constituting an inside portion; where the outside portion and the inside portion are superimposed on each other;
a housing portion having an opening and an inner area for containing cigarette butts;
a lid portion that can open and close the opening of the housing portion;
a fire extinguishing portion that is inside the housing portion; the fire extinguishing portion having a cylindrical shape, and which is opened to contain a tip of a cigarette inserted into the housing portion to be extinguished; the fire extinguishing section comprising:
a first extinguishing section for accommodating and extinguishing a tip side of a regular sized cigarette;
a second extinguishing section having a smaller diameter than the first extinguishing section for accommodating and extinguishing a tip side of a slim sized cigarette provided in connection with the first extinguishing section; and
a cleaning tool for the extinguishing section.

2. The portable ashtray of claim 1, wherein the fire extinguishing portion comprises a metal pipe member forming the first extinguishing section and the second fire extinguishing section, wherein an inner diameter of the fire extinguishing portion is varied in two steps in the axial direction and is attached inside the housing section via a belt member.

3. The portable ashtray of claim 2, comprising a first butt portion between the first and second extinguishing sections that butts up against the tip of a regular size cigarette and a second butt portion on the second extinguishing section that butts up against the tip of a slim size cigarette.

4. The portable ashtray of claim 3, wherein the first butt portion is formed to have a smooth curved surface.

5. The portable ashtray of claim 3, wherein the second butt portion has an ejection hole that allows ashes of an inserted slim-size cigarettes to fall into the housing section.

6. The portable ashtray of claim 1, wherein the cleaning tool comprises a brush member having a brush section and a handle and a housing pipe for accommodating the brush member, wherein the brush member is configured to removably installed into a housing hole in the housing section via the housing pipe.

7. The portable ashtray of claim 2, wherein the metal pipe member is affixed to an interior of the housing portion.

8. The portable ashtray of claim 1, wherein the second butt portion has an ejection hole that allows ashes of an inserted slim-size cigarettes to fall into the housing section.
